(19) United States
(12) Patent Application Publication
(10) Pub. No.: US 2010/0201106 A1
(43) Pub. Date: Aug. 12, 2010

(54) Knee airbag

(75) Inventors: Jason Carl Lisseman, Shelby Township, MI (US); Maria Therese Sequin, Royal Oak, MI (US); Henning Wigger, Detroit, MI (US)

Correspondence Address: FOLEY AND LARDNER LLP;SUITE 500, 3000 K STREET NW, WASHINGTON, DC, 20007, US

(73) Assignee: TK HOLDINGS INC.

(21) Appl. No.: 12/379,060

(22) Filed: Feb. 11, 2009

(51) Int. Cl. B60R 21/16

(52) U.S. Cl. 280/730.1

(57) ABSTRACT

The present invention relates to a knee airbag for a vehicle with a reinforcement configured to form a seal with an inflator. The knee airbag that includes an opening, an inflator inserted within the opening of the knee airbag, and a reinforcement formed around the opening of the airbag, wherein the reinforcement is configured to form a seal with the inflator. Such an arrangement may advantageously minimize or prevent the release of inflation gas through the opening for the inflator.

### BACKGROUND

The present application relates generally to the field of airbags for vehicles. In particular, the present invention relates to a knee cushion or airbag for a vehicle with a reinforcement configured to form a seal with an inflator.

FIG. 1 shows an arrangement for a conventional knee airbag (KAB) module 10, which includes a housing 20 and an inflator 30. As shown in FIG. 1, the inflator 30 is positioned outside of the housing 20 so that inflation gas from the inflator 30 is directed into a diffuser 40 that is external to the housing 20, which in turn directs the gas into the knee airbag, which is located within the housing 20.

Unlike other airbags, such as driver's side airbags and passenger side airbags, knee airbags are typically designed with coatings, sealed seams, and no vents so that the airbag remains inflated to at least some degree following deployment. However, the insertion area of an inflator into a knee airbag may permit inflation gas to escape from the knee airbag, thereby allowing the airbag to deflate and compromising the performance of the airbag.

### SUMMARY

A disclosed embodiment relates to a knee airbag device that includes a knee airbag that includes an opening, an inflator, and a reinforcement formed around the opening of the airbag. The inflator is inserted within the opening of the knee airbag and the reinforcement may be configured to form a seal with the inflator.

Another disclosed embodiment relates to a knee bolster for a vehicle that includes an inflatable knee bolster that includes an opening, an inflator, and a reinforcement formed around the opening of the bolster. The inflator is inserted within the opening of the knee bolster and the reinforcement is configured to form a seal with the inflator.

### BRIEF DESCRIPTION OF THE DRAWINGS

These and other features, aspects, and advantages of the present invention will become apparent from the following description, appended claims, and the accompanying exemplary embodiments shown in the drawings, which are briefly described below.

FIG. 1 is an isometric view of a conventional knee airbag module.

FIG. 2 is a side view of an exemplary arrangement of a knee airbag within a vehicle in relation to a passenger.

FIG. 3 is an illustration of a knee airbag without an inflator, according to an exemplary embodiment.

FIG. 4 is a an illustration of a knee airbag with an inflator, according to an exemplary embodiment.

FIG. 5 is an illustration of a knee airbag with an inflator and a clamp, according to an exemplary embodiment.

FIG. 6 is a top view of a knee airbag device in a housing, according to an exemplary embodiment.

FIG. 7 is an isometric view of the arrangement shown in FIG. 6.

### DETAILED DESCRIPTION

FIG. 2 shows a side view of an exemplary arrangement of a knee airbag within a vehicle in relation to a passenger upon deployment of the airbag. As shown in FIG. 2, the knee airbag 70 may be mounted in a housing 60 located underneath the dashboard or instrument panel 50 of the vehicle so that the airbag 70 deploys in front of the a vehicle occupant's leg 80, in particular the occupant's knee, to minimize injury to the occupant's legs in an accident. Although a knee airbag 70 is shown in FIG. 2, the features of the present invention are applicable to an inflatable knee bolster, which would be positioned in a similar location as the knee airbag 70 and housing 60 shown in FIG. 2 to minimize injury an occupant's legs.

An object is to provide a knee airbag, cushion or bolster that minimizes or prevents the release of inflation gas through the opening for the inflator.

In an embodiment of the invention, a reinforcement is provided in a knee cushion at an opening that is provided for an inflator. The reinforcement enhances the strength of the cushion at the opening for the inflator and seals with the inflator, thus minimizing or preventing the release of inflation gas through the opening for the inflator.

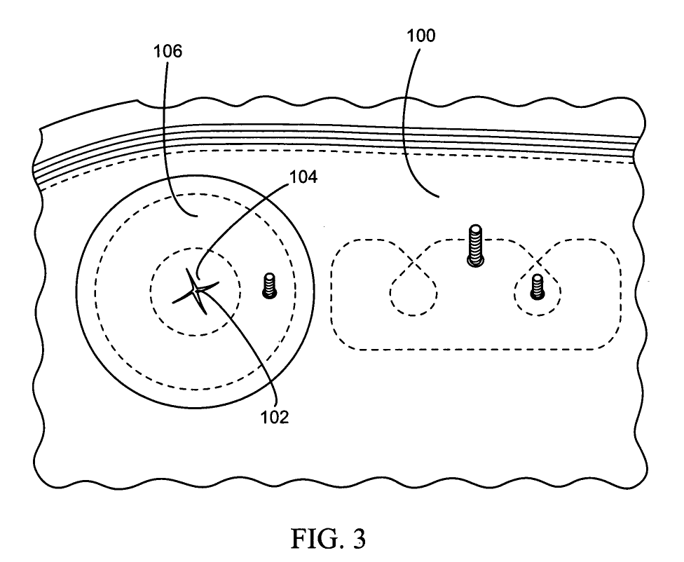

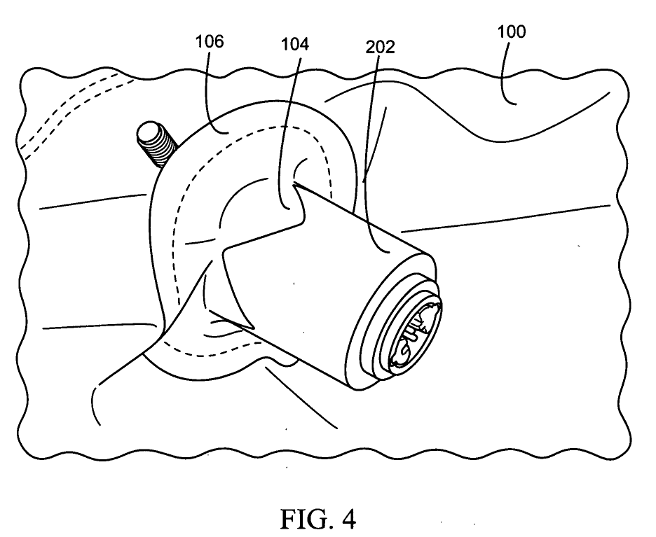

Referring to FIG. 3, an illustration of a knee airbag 100 is shown without an inflator, according to an exemplary embodiment. The knee airbag 100 includes a reinforcement device or reinforcement 106 that is located at an opening (not shown) in the airbag 100 for an inflator. For example, the opening in the airbag 100 for the inflator may be located in a lower panel of the knee airbag 100.

The reinforcement 106 includes an opening 102 for an inflator. The opening 102 of the reinforcement 106 is generally aligned with the opening of the airbag 100 so that the inflator may provide inflation fluid to the interior of the knee airbag 100. The inflator may be connected to the knee airbag 100 by inserting the inflator through the opening 102, as will be described in greater detail below. The opening 102 of the reinforcement 106 may be smaller than the opening of the knee airbag 100 such that the opening 102 forms the opening that the inflator is inserted into.

The reinforcement 106 is configured to enhance the strength of the knee airbag 100 at the opening 102 and to seal with the inflator when the inflator is inserted in the opening 102. Due to the tight tolerances, strength, and/or elasticity of the reinforcement 106, a tight seal is formed between the inflator and the reinforcement 106. For example, the tight tolerances of the opening 102 in the reinforcement 106 provide a tight fit with an inflator, while the elasticity of the reinforcement 106 may permit the reinforcement 106 to stretch over the surface of the inflator so that the reinforcement 106 conforms and seals to the surface of the inflator, while the enhanced strength of the reinforcement 106 helps to prevent rupture of the reinforcement despite the tight fit against the inflator. Such an arrangement advantageously minimizes or prevents the release of inflation gas through the opening 102, thus improving the performance of the knee airbag 100. Furthermore, a direction connection between the knee airbag 100 and inflator is formed by inserting the inflator through the opening 102.

The reinforcement 106 may be formed by a patch, for example. Such a patch may joined to the knee airbag 100 to reinforce the airbag. The patch may be made of a fabric, either coated or uncoated, a plastic sheet, or other reinforcement materials used in the art. The patch may be joined to the knee airbag 100 by, for example, sewing or other methods used in the art. The patch may be joined to an interior of the knee airbag 100 or an exterior of the knee airbag 100.

According to a further example, the reinforcement 106 may be formed by a patch, as described above, which is coated. Such a coating for the patch may be made with an amount of coating that is significantly greater than an amount of coating used for the remainder of the knee airbag 100, such as at locations removed from the reinforcement. For example the knee airbag, besides the patch forming the reinforcement 106, may be coated with a coating amount of approximately 35 g/m². The patch forming the reinforcement may be coated with a coating amount of at least 50 g/m², or at least 75 g/m², or at least 100 g/m², or at least 120 g/m², or at least 140 g/m². The coating material may be a silicon material.

In another example, the opening 102 may be formed by a x-shaped or cross-shaped cut, as shown in the example of FIG. 3. Such an x-shaped cut may provide an opening 102 with tight tolerances such that the reinforcement 106 may seal against a surface of an inflator, as described herein.

As shown in the example of FIG. 3, the x-shaped cut may provide fabric portions 104 in the reinforcement 106. As shown in the example of FIG. 3, the fabric portions 104 may have the shape of triangles, although other shapes are also possible by altering the geometry of the opening 102. In another example, the cut in the airbag can be generally Y-shaped to provide three fabric portions instead of four fabric portions, as provided by an x-shaped cut. The cut can have other configurations to provide greater numbers of fabric portions, such as five or more fabric portions.

The fabric portions 104 may be used to seal an inflator to the reinforcement 106. For example, the fabric portions 104, like the remainder of the reinforcement 106, may have a tight tolerance, high strength, and a degree of elasticity so that the fabric portions 104 may tightly stretch over and contact an outer surface of an inflator. Such fabric portions 104 may lie flat against the outer surface of the inflator to enhance the seal provided by the reinforcement 106. In another example, the fabric portions 104 provide the surface of the reinforcement 106 that seals against an inflator.

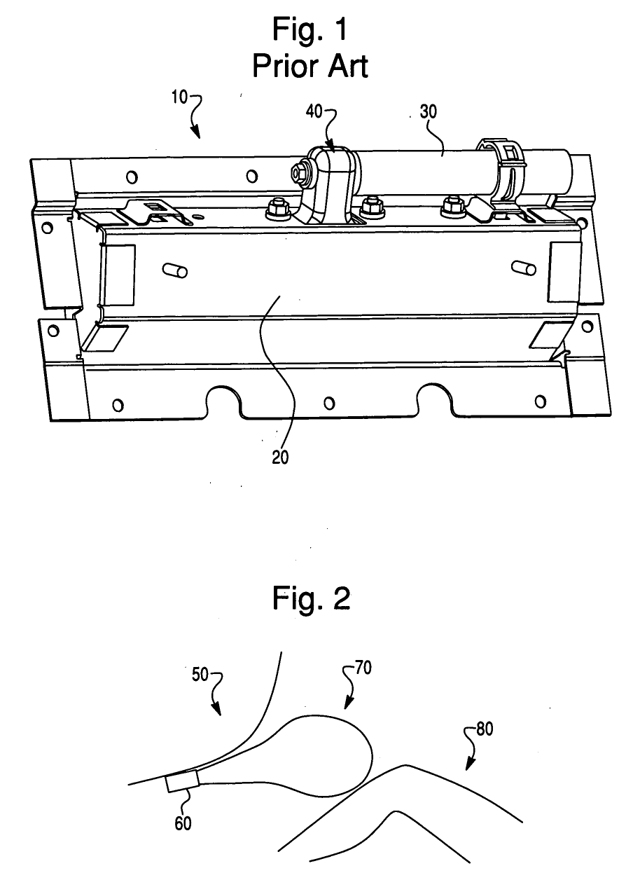

FIG. 4 shows an example of the knee airbag 100 when an inflator 202 has been inserted into the opening 102 of FIG. 1. As shown in the example of FIG. 4, when the inflator 202 is inserted or pushed through the opening 102, such as one formed by a x-shaped cut that forms fabric portions 104, the fabric portions 104 of the reinforcement are pushed outwards in the direction that the inflator 202 is pushed through the opening 102. For example, the inflator 202 may be pushed through the opening 102 towards an interior of the knee airbag 100 so that the fabric portions 104 are also pushed into an interior of the knee airbag 100, or the inflator 202 may be pushed through the opening 102 towards an exterior of the knee airbag 100 so that the fabric portions 104 are also pushed outwards to an exterior of the knee airbag 100.

Inserting an inflator 202 into the opening 102 of the reinforcement 106 so that the inflator 202 at least partially projects from the opening 102 is beneficial because the portion of the inflator projecting to an exterior of the knee airbag 100 may be accessed by a user, such for making connections and for installation of the knee airbag in a vehicle. Conventional knee airbag modules that have an external inflator for access, such as the arrangement shown in FIG. 1, provide arrangements that contribute to gas leakage from the knee airbag, such as from the opening for the inflator. In another arrangement the inflator can be located completely within the airbag with a wire harness attached to the inflator such that the wire harness at least partially projects from the opening of the airbag.

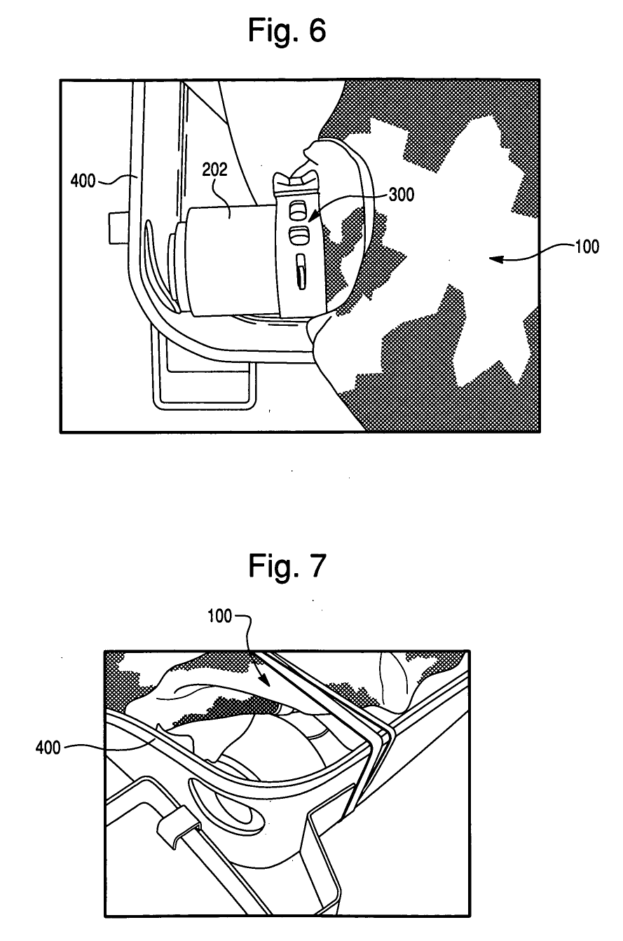

The example of FIG. 6 shows a top view of a knee airbag 100 with an inflator 202 inserted into the opening 102 of the reinforcement 106, in which the knee airbag arrangement has been placed within a housing 400 in preparation for installation of the knee airbag arrangement in a vehicle. FIG. 7 shows a top view of the arrangement of FIG. 6. As shown in the examples of FIGS. 6 and 7, by inserting the inflator 202 into the knee airbag 100 so that at least a portion of the inflator 202 projects from the knee airbag 100 permits simple access to the inflator 202, even when the arrangement is placed within a housing 400 because the housing may be provided with an opening to provide access to the inflator 202, as shown in FIGS. 6 and 7.

According to an example, the reinforcement 106 may be configured to release gas from the knee airbag 100. For example, the reinforcement 106 may be configured to release gas when the knee airbag is subjected to a high energy input condition, such as when a large vehicle occupant strikes the knee airbag 100 with great force and/or at high speed. Under non-high energy input conditions, the reinforcement 106 is configured to provide a seal with an inflator, as discussed herein. Such an arrangement permits the reinforcement to act like a pressure relief valve for the knee airbag under high energy input conditions. As a result, the knee airbag may function without being ruptured or destroyed when the knee airbag is subjected to such a high energy input condition, and the knee airbag may include a seal between a reinforcement of the knee airbag and an inflator under non-high energy input conditions. The reinforcement may be configured to permit gas to escape from the knee airbag 100 until an internal pressure of the knee airbag 100 is reduced, thus permitting the reinforcement 106 to reestablish a seal with an inflator

In another example, fabric portions 104 of the reinforcement 106 may be configured to release gas from the knee airbag 100. The fabric portions 104 may allow gas to be released from the knee airbag 100 by, for example, flaring outwards from an outer surface of an inflator so a seal between the fabric portions 104 and the inflator is broken and gas may escape between the fabric portions 104 and the inflator. According to this example, the fabric portions 104 may flare out and permit gas to escape from the knee airbag 100 until an internal pressure of the knee airbag 100 is reduced, thus permitting the fabric portions 104 to reestablish a seal with an inflator.

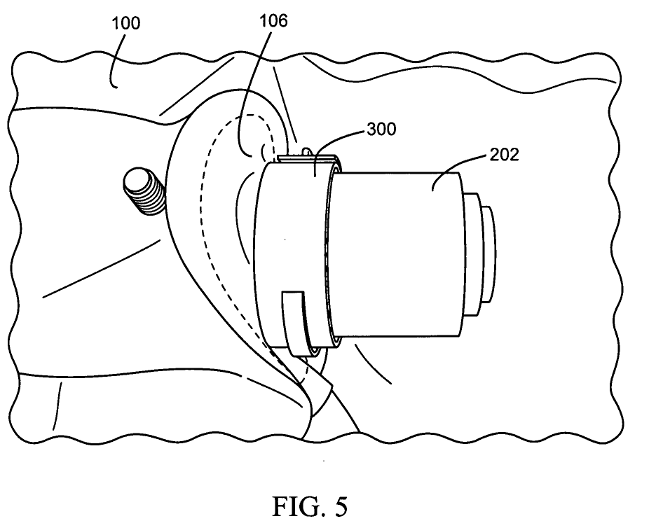

The example of FIG. 5 shows another arrangement of a knee airbag 100 with an inflator 202 inserted through an opening in a reinforcement 106 and a clamp 300 that is placed over the portion of the reinforcement 106 that contacts and/or seals with the inflator 202. Such a clamp 300 may be used to enhance the contact and seal between the reinforcement 106 and inflator 202. In a further example, the clamp 300 may be positioned over fabric portions 104 and the inflator 106 to clamp the fabric portions 104 against an outer surface of the inflator. However, the clamp 300 is optional and not necessary in these examples to form an effective seal between the reinforcement 106 and the inflator.

The features of the reinforcement and clamp discussed above in regard to the knee are also applicable to an inflatable knee bolster. For example, a knee bolster for a vehicle may be provided with an inflatable knee bolster with an opening and a reinforcement 106, as discussed above in regard to the knee airbag of FIGS. 2-7.

While exemplary embodiments are illustrated in the figures and described above, it should be understood that these embodiments are offered by way of example only. For example, the teachings herein may be applied to any knee airbag and is not limited to a knee airbag.

What is claimed is:

1. A knee airbag device, comprising:
a knee airbag that includes an opening,
an inflator, wherein the inflator is inserted within the opening of the knee airbag, and
a reinforcement formed around the opening of the airbag, wherein the reinforcement is configured to form a seal with the inflator.

2. The knee airbag device of claim 1, wherein the reinforcement is formed by a patch that is joined to the knee airbag.

3. The knee airbag device of claim 2, wherein the patch is coated with a coating.

4. The knee airbag device of claim 3, wherein the coating is formed with a coating weight of at least 100 g/m2.

5. The knee airbag device of claim 1, wherein the reinforcement forms the opening in the knee airbag.

6. The knee airbag device of claim 5, wherein the opening is formed by an x-shaped cut.

7. The knee airbag device of claim 6, wherein the x-shaped cut forms fabric portions that are configured to seal with the inflator.

8. The knee airbag device of claim 7, wherein the fabric portions are positioned in an interior of the knee airbag.

9. The knee airbag device of claim 7, wherein the fabric portions are positioned in an exterior of the knee airbag.

10. The knee airbag device of claim 7, wherein the fabric portions are configured to release gas from the knee airbag when the knee airbag is subjected to a high energy input condition.

11. The knee airbag device of claim 1, wherein the reinforcement is configured to release gas from the knee airbag when the knee airbag is subjected to a high energy input condition.

12. The knee airbag of claim 7, further comprising a clamp, wherein the clamp is configured to clamp the fabric portions against the inflator.

13. The knee airbag of claim 1, further comprising a clamp, wherein the clamp is configured to clamp the reinforcement against the inflator.

14. An knee bolster for a vehicle, comprising:
an inflatable knee bolster that includes an opening,
an inflator, wherein the inflator is inserted within the opening of the knee bolster, and
a reinforcement formed around the opening of the bolster, wherein the reinforcement is configured to form a seal with the inflator.

15. The knee bolster of claim 14, wherein the reinforcement forms the opening in the knee bolster.

16. The knee bolster of claim 15, wherein the opening is formed by an x-shaped cut.

17. The knee bolster of claim 16, wherein the x-shaped cut forms fabric portions that are configured to seal with the inflator.

18. The knee bolster of claim 17, wherein the fabric portions are configured to release gas from the knee bolster when the knee bolster is subjected to a high energy input condition.

19. The knee bolster of claim 14, wherein the reinforcement is configured to release gas from the knee bolster when the knee bolster is subjected to a high energy input condition.

20. The knee bolster of claim 14, further comprising a clamp, wherein the clamp is configured to clamp the reinforcement against the inflator.
